(19) United States
(12) Patent Application Publication
(10) Pub. No.: US 2006/0094808 A1
(43) Pub. Date: May 4, 2006

(54) Vinyl chloride resin composition and method for preparation thereof

(76) Inventors: Youngjin Kim, Daejeon-city (KR); Bhomri Kim, Daejeon-city (KR); Chayeon Seo, Yeosu-city (KR); Jeong Hwan Koh, Daejeon-city (KR)

Correspondence Address: CANTOR COLBURN, LLP, 55 GRIFFIN ROAD SOUTH, BLOOMFIELD, CT, 06002, US

(21) Appl. No.: 11/260,330

(22) Filed: Oct. 27, 2005

(30) Foreign Application Priority Data
Nov. 3, 2004 (KR) 10-2004-0088772

(51) Int. Cl. C08K 9/00; C08K 3/22

(52) U.S. Cl. 524/430; 523/200

(57) ABSTRACT

Provided are a vinyl chloride resin composition containing a vinyl chloride monomer and an organo-modified metal oxide nanoparticle which can be used in exterior construction materials due to markedly improved thermal stability and weather resistance, which are considered weaknesses of vinyl chloride resins, and a method of preparing the same.

This application claims the benefit of the filing date of Korean Patent Application No. 10-2004-0088772, filed on 3 Nov. 2004, in the Korean Intellectual Property Office, the disclosure of which is incorporated herein in its entirety by reference.

### TECHNICAL FIELD

The present invention relates to a vinyl chloride resin composition and a method of preparing the same, and more particularly, to a vinyl chloride resin composition which can be used in exterior construction materials due to markedly improved thermal stability and weather resistance, which are considered weaknesses of vinyl chloride resins, and a method of preparing the same.

### BACKGROUND ART

Thermal stability is a known weakness of vinyl chloride resins. Until now, a number of methods for preparing vinyl chloride resins with improved thermal stability have been suggested. However, these methods are limited in the improvements in fundamental properties provided to the resins.

Structural defects of allylic chlorine, tertiary chlorine, etc., in a vinyl chloride polymer, which result from a dehydrochlorination reaction during polymerization, deteriorate the thermal stability of the vinyl chloride resin. The bonding energy between carbon and chlorine in this case is very low compared to the bonding energy between carbon and chlorine in normal structures. Further, the chain transfer breaks the bond between carbon and chlorine, and the site of broken bond becomes a polymerization activation point, which causes the deterioration of the thermal stability of the vinyl chloride resin. The vinyl chloride resin undergoes a dehydrochlorination reaction caused by the heat or ultraviolet radiation applied during processing, and this reaction causes discoloration of the resin, or deterioration or alteration of the resin properties.

To solve this problem during processing, there has been an attempt to inhibit the generation of radicals or ions upon thermal degradation of a vinyl chloride resin and to control the rate of thermal degradation of the resin by adding an organometallic compound containing a metal such as Ba, Zn, Ca or Pb to a prepared vinyl chloride resin. Recently, methods of using thermal stabilizers of various forms, such as metal-based stabilizers or organic compound-based stabilizers, have also been introduced. However, the environmental problems brought upon by using heavy metal stabilizers and the high prices thereof restrict the use of such stabilizers.

Vinyl chloride resins have excellent mechanical strength and chemical resistance, and thus, they are widely used as industrial and domestic materials in pipes, window frames, sheets, films and the like. However, molding products made of vinyl chloride resins for rigid use are poor in thermal stability and weather resistance. Thus, despite their excellent performance compared with other resins of similar prices, vinyl chloride cannot be applied to applications requiring special functions.

As a solution to such problem, Japanese Laid-open Patent Publication No. 2002-332308 discloses a method of mixing a small amount of a polyvinyl alcohol-based dispersant with an anhydrous powder of a vinyl chloride polymer resin. However, since this method does not differ from conventionally known preparation methods of polymerization, this method barely improves the thermal stability and weather resistance of the resin, and expected effects of such improvement are not many.

Furthermore, to improve weather resistance, a technique for processing vinyl chloride resins in which a large amount of metal oxide such as titanium dioxide is introduced when processing the resin has been used.

However, the conventional methods cannot be used to improve thermal stability and weather resistance at the same time, and thus research into a method for preparing a vinyl chloride resin which can improve both the thermal stability and weather resistance of a resin is still required.

### DISCLOSURE OF THE INVENTION

In order to solve the above-described problems of the prior art, the present invention provides a vinyl chloride resin composition which has remarkably improved thermal stability and weather resistance, which are considered weaknesses of vinyl chloride resins, and thus can be used as an exterior construction material for, for example, siding, a window frame, fences or the like, and a method of preparing the same.

According to an aspect of the present invention, there is provided a vinyl chloride resin composition comprising: a) 100 parts by weight of a vinyl chloride polymer resin; and b) 0.1 to 30 parts by weight of an organo-modified metal oxide nanoparticle.

According to another aspect of the present invention, there is provided a method of preparing a vinyl chloride resin by suspension polymerization, wherein an organo-modified metal oxide nanoparticle is introduced at the beginning of a polymerization reaction.

### BRIEF DESCRIPTION OF THE DRAWING

FIG. 1 is a diagram conceptually illustrating the rutile structure and anatase structure of titanium dioxide, which is an exemplary metal oxide used in a vinyl chloride resin composition according to an embodiment of the present invention.

### BEST MODE FOR CARRYING OUT THE INVENTION

A vinyl chloride resin composition according to an embodiment of the present invention includes 100 parts by weight of a vinyl chloride polymer resin and 0.1 to 30 parts by weight of an organo-modified metal oxide nanoparticle.

The vinyl chloride polymer resin used in the present invention can be prepared using monomers conventionally used in vinyl chloride resins which optionally further include vinyl acetate, acrylates, methacrylates, olefins (ethylene, propylene, etc.), unsaturated fatty acids (acrylic acid, methacrylic acid, itaconic acid, maleic acid, etc.) and anhydrides of the unsaturated fatty acids.

The amount of the organo-modified metal oxide nanoparticle may be in the range of 0.1 to 30 parts by weight based on 100 parts by weight of the vinyl chloride polymer resin. When the amount is less than 0.1 parts by weight, the thermal stability of the vinyl chloride resin composition becomes poor, and a composition having irregularly structured resin particles is obtained. When the amount exceeds 30 parts by weight, stable resin properties cannot be obtained, and the resulting resin particles become nonuniform.

The particle size of the organo-modified metal oxide nanoparticle may be 10 to 300 nm.

The organo-modified metal oxide nanoparticle is a kind of photocatalyst, which maximizes a light reflecting effect and thus improves the degree of whiteness, thermal stability and weather resistance of the vinyl chloride resin composition.

The metal oxide nanoparticle may be titanium dioxide, zinc oxide, cadmium sulfide, tungsten trioxide, zirconium oxide, aluminum oxide, silicon oxide or the like, and titanium dioxide is preferable. Titanium dioxide can be used semi-permanently since it does not undergo any change even upon exposure to light, it has higher oxidizing power than chlorine or ozone and thus has strong sterilizing power, and it has the ability to decompose organic products into carbon dioxide and water. Also, titanium dioxide is not harmful to humans so it can be used in window frames, paper, rubber, paint, plastics, cosmetics and the like.

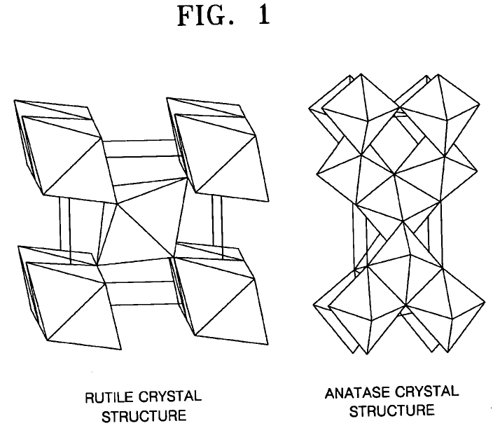

Among the aforementioned metal oxides, titanium dioxide can be classified into three categories depending on its crystal structure, and in general, the rutile structure and the anatase structure as shown in FIG. 1 are mainly used.

Since rutile crystals have much more densely arranged titanium atoms and oxygen atoms than anatase crystals, the rutile structure is slightly more stable against light and absorbs more light, particularly in the ultraviolet region (360 to 400 nm), thus protecting the polymer. Further, the rutile structure also has excellent stability against organic/inorganic acids, alkalis, gases and the like. On the other hand, titanium dioxide with the anatase structure produces relatively more OH groups compared to the rutile structure and thus decomposes the resin in paint to cause a chalking phenomenon in which the film is blanched. Therefore, the anatase structure is inapplicable to the present invention.

The vinyl chloride resin composition may further contain 0.1 to 10 parts by weight of an acrylic monomer which is copolymerized with the vinyl chloride resin based on 100 parts by weight of the vinyl chloride polymer resin.

This acrylic monomer should be copolymerizable with the vinyl chloride resin and have carbon-carbon double bonds to facilitate chain transfer. The monomer should be of such a kind that can produce a polymer which has a glass transition temperature (Tg) of 100 to 250° C. to ensure that the vinyl chloride resin composition has good processability.

The acrylic monomer may be a conventional acrylic monomer, and in particular, the monomers of the following Formulae 1 and 2 may be used:
[Formula 1] 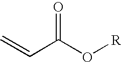
[Formula 2]

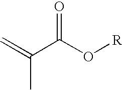

In Formula 1 and Formula 2, R is hydrogen, a linear or branched alkyl having 1 to 20 carbon atoms, preferably 1 to 4 carbon atoms, an aryl having 3 to 16 carbon atoms, or a cycloalkyl having 5 to 8 carbon atoms.

Specifically, the acrylic monomer may be methyl (meth)acrylate, ethyl (meth)acrylate, n-butyl (meth)acrylate, isobutyl acrylate, cyclohexyl acrylate, glycidyl (meth)acrylate, phenyl (meth)acrylate, methoxyethyl acrylate, methyl-2-cyanoacrylate, benzyl (meth)acrylate, allyl-2-cyanoacrylate, or 1-ethylpropyl-2-cyanoacrylate.

The amount of the acrylic monomer is determined such that the characteristic particulate form of the vinyl chloride resin is maintained so as to ensure the intrinsic properties of molded articles made of the resin, such as tensile strength, surface strength and the like, are not affected. The amount of the monomer may be 0.1 to 10 parts by weight based on 100 parts by weight of the vinyl chloride resin. If the amount of the monomer is within the above-mentioned range, successive reactions of hydrogen chloride, which is an initial product from decomposition deteriorating the thermal stability of the vinyl chloride resin, are inhibited, and thus a vinyl chloride resin with excellent thermal stability can be produced.

The vinyl chloride resin composition according to the present invention may be further processed according to the use if required, for example, by adding additives such as a thermal stabilizer, a lubricant, a processing aid, an antioxidant, or a photostabilizer.

Hereinafter, a method of preparing the vinyl chloride resin composition according to the present invention will now be described in detail.

The method of preparing the vinyl chloride resin composition according to the present invention includes: (a) preparing a polymerization feed mixture by mixing 100 parts by weight of a vinyl chloride monomer and 0.1 to 30 parts by weight of an organo-modified metal oxide nanoparticle; and (b) conducting suspension polymerization on the resulting mixture.

The vinyl chloride monomer can be one of the monomers described above.

The amount of the organo-modified metal oxide nanoparticle may be 0.1 to 30 parts by weight based on 100 parts by weight of the vinyl chloride monomer. When the amount is less than 0.1 parts by weight, the thermal stability of the vinyl chloride resin obtained by polymerization becomes poor, and a composition having irregularly structured resin particles is obtained. When the amount exceeds 30 parts by weight, the amount of a dispersant to be added during the polymerization reaction must be increased, which deteriorates polymerization stability and causes non-uniformity of the resin particles.

The metal oxide nanoparticle may be used in an organically modified sol state or in a powder state.

Conventionally, titanium dioxide is used as a white pigment additive during the processing of vinyl chloride resins. However, the organo-modified metal oxide nanoparticle is introduced together with the vinyl chloride monomer prior to the initiation of polymerization, which will be described later. By introducing the metal oxide nanoparticle immediately prior to the polymerization, the rate of polymerization in the reactor can be suppressed, and scales may be formed during the polymerization process. Therefore, in order to more efficiently carry out the reaction, the metal oxide nanoparticle can be used in an organically modified sol state.

Therefore, the method of preparing the vinyl chloride resin composition may further include organically modifying the metal oxide nanoparticle.

When organically modifying the metal oxide nanoparticle, the metal oxide nanoparticle may be mixed with an organic substance for organic modification at a ratio of 1:1 to 1:4. When the proportion of the metal oxide nanoparticle is excessively high during the organic modification, viscosity is too high, and the metal oxide nanoparticles are not uniformly dispersed in the organic substance, and thus solid particles exist in intact form. In this case, the solid particles cannot penetrate the vinyl chloride monomer droplets and thus remain in the aqueous solution phase. On the other hand, when the proportion of the organic substance is excessively high, its influence on the reaction conditions such as pH, protective colloid properties, etc., becomes significant.

Organic modification of the metal oxide nanoparticle can be carried out by using an organic substance, such as a cellulose-based dispersant, which may be methyl cellulose, hydroxypropylmethylcellulose, hydroxyethylmethylcellulose, etc., an alkyl- or arylcarboxylic acid compound having 6 to 18 carbon atoms, or an alkyl- or arylphosphoric acid compound having 6 to 18 carbon atoms.

In particular, the cellulose-based dispersant may be used in a 0.5 to 15 wt % solution, and preferably, in a 1 to 7 wt % solution. At a dilute concentration of 0.5 wt % or lower, it is difficult for the metal oxide nanoparticles to be sufficiently dispersed, and thus efficiency is lowered. At a high concentration exceeding 15 wt %, viscosity of the solution is too high, and when the dispersant is introduced, the high viscosity would cause inconvenience in the modification process. Further, in addition to increasing the dispersion of the metal oxide nanoparticles, the dispersants significantly affect the vinyl chloride monomer droplets, and particles are formed in an unstable form.

The compounds used in the organic modification of the metal oxide nanoparticle is advantageous in that they do not significantly affect pH during the reaction and has both a hydrophilic group and a hydrophobic group, thus having excellent affinity to the suspension or emulsion, which is a reaction medium, and to the vinyl chloride monomer. The compounds also evenly disperse the metal oxide nanoparticles and easily participate in the reaction with the vinyl chloride monomer in the reaction medium, thus not forming scales on the inner walls of the reactor and the stirrer after the reaction.

The present invention also provides a method of preparing vinyl chloride resin by suspension polymerization using the above-described components. In this method, the organo-modified metal oxide nanoparticle is introduced at the beginning of the reaction. Here, both the vinyl chloride monomer and the organo-modified metal oxide nanoparticle are polar, and thus, after the reaction is initiated, the organo-modified metal oxide nanoparticle penetrates into the vinyl chloride monomer droplets to react. Furthermore, when an acrylic monomer is further used for the reaction, a copolymerization reaction will occur between a composite of the vinyl chloride monomer and the organo-modified metal oxide nanoparticle, and the acrylic monomer.

As described above, the organo-modified metal oxide nanoparticle forms a composite with the vinyl chloride monomer for polymerization, and this composite significantly improves the thermal stability and weather resistance of the vinyl chloride resin. These properties have been considered a weak point of vinyl chloride resins, but with these properties, the vinyl chloride resin can be advantageously used in exterior construction materials for siding, window frames, fencers, and the like.

Hereinafter, the present invention will be described in more detail with reference to the following examples, which are for illustrative purposes only, and not intended to limit the scope of the invention.

### EXAMPLE

### Example 1

180 parts by weight of deionized water, 1 part by weight of titanium dioxide nanoparticle which was organically modified with 0.5 parts by weight of oleic acid, 0.25 parts by weight of methyl methacrylate monomer, 0.07 parts by weight of t-butylperoxy-neodecanoate (BND) as a reaction initiator, and 0.3 parts by weight of polyvinyl alcohol-based dispersant were simultaneously introduced to a 40-L high pressure reactor. Next, the reactor was subjected to a vacuum, and 100 parts by weight of vinyl chloride were introduced while stirring. Polymerization was carried out at an elevated temperature of 58° C. When the reactor pressure reached 7 kg/cm², the reactor was cooled, and the unreacted vinyl chloride monomer was recovered and removed. Subsequently, the product was dehydrated and dried to provide a vinyl chloride resin.

### Example 2

A vinyl chloride resin was prepared in the same manner as in Example 1, except that 0.03 parts by weight of a 5% aqueous solution of hydroxypropylmethylcellulose dispersant were used instead of the oleic acid.

### Example 3

180 parts by weight of deionized water, 1 part by weight of powdered titanium dioxide, 0.25 parts by weight of methyl methacrylate monomer, 0.07 parts by weight of t-butylperoxy-neodecanoate (BND) as a reaction initiator, and 0.3 parts by weight of polyvinyl alcohol dispersant were simultaneously introduced into a 40-L high pressure reactor. Next, the reactor was subjected to a vacuum, and 100 parts by weight of vinyl chloride were introduced while stirring. Polymerization was carried out at an elevated temperature of 58° C. When the reactor pressure reached 7 kg/cm², the reactor was cooled, and the unreacted vinyl chloride monomer was recovered and removed. Subsequently, the product was dehydrated and dried to provide a vinyl chloride resin.

### Example 4

A vinyl chloride resin was prepared in the same manner as in Example 1, except that 1 part by weight of the methyl methacrylate monomer was used.

### Example 5

180 parts by weight of deionized water, 4 parts by weight of titanium dioxide nanoparticle which was organically modified with 0.03 parts by weight of a 5% aqueous solution of hydroxypropylmethylcellulose dispersant, 0.25 parts by weight of a methyl methacrylate monomer, 0.07 parts by weight of t-butylperoxy-neodecanoate (BND) as a reaction initiator, and 0.3 parts by weight of polyvinyl alcohol-based dispersant were simultaneously introduced into a 40-L high pressure reactor. Next, the reactor was subjected to a vacuum, and 100 parts by weight of vinyl chloride were introduced while stirring. Polymerization was carried out at an elevated temperature of 58° C. When the reactor pressure reached 7 kg/cm², the reactor was cooled, and the unreacted vinyl chloride monomer was recovered and removed. Subsequently, the product was dehydrated and dried to provide a vinyl chloride resin.

### Example 6

180 parts by weight of deionized water, 1 part by weight of titanium dioxide nanoparticle which was organically modified with 0.03 parts by weight of a 5% aqueous solution of hydroxypropylmethylcellulose dispersant, 0.25 parts by weight of methyl methacrylate monomer, and 0.07 part by weight of t-butylperoxy-neodecanoate (BND) as a reaction initiator were simultaneously introduced into a 40-L high pressure reactor. Next, the reactor was subjected to a vacuum, 100 parts by weight of vinyl chloride were introduced while stirring, and the stirring was continued for one hour at room temperature. Then, 0.3 parts by weight of a polyvinyl alcohol-based dispersant were added to the result, and subsequently stirring was performed for 30 minutes at room temperature. Polymerization was carried out at an elevated temperature of 58° C. When the reactor pressure reached 7 kg/cm², the reactor was cooled, and the unreacted vinyl chloride monomer was recovered and removed. Subsequently, the product was dehydrated and dried to provide a vinyl chloride resin.

### Example 7

180 parts by weight of deionized water, 1 part by weight of titanium dioxide nanoparticle which was organically modified with 0.03 parts by weight of a 5% aqueous solution of hydroxypropylmethylcellulose dispersant, and 0.07 parts by weight of t-butylperoxy-neodecanoate (BND) as a reaction initiator were simultaneously introduced into a 40-L high pressure reactor. Next, the reactor was subjected to a vacuum, 100 parts by weight of vinyl chloride were introduced while stirring, and the stirring was continued for one hour at room temperature. Then, 0.3 parts by weight of a polyvinyl alcohol-based dispersant and 0.25 parts by weight of a methyl methacrylate monomer were added to the result, and subsequently stirring was performed for 30 minutes at room temperature. Polymerization was carried out at an elevated temperature of 58° C. When the reactor pressure reached 7 kg/cm², the reactor was cooled, and the unreacted vinyl chloride monomer was recovered and removed. Subsequently, the product was dehydrated and dried to provide a vinyl chloride resin.

### Comparative Example 1

180 parts by weight of deionized water, 0.07 parts by weight of t-butylperoxy-neodecanoate (BND) as a reaction initiator, and 0.3 parts by weight of a polyvinyl alcohol-based dispersant having a degree of saponification of 70 to 90 mol % were simultaneously introduced into a 40-L high pressure reactor. Next, the reactor was subjected to a vacuum, and 100 parts by weight of vinyl chloride were introduced while stirring. Polymerization was carried out at an elevated temperature of 58° C. When the reactor pressure reached 7 kg/cm², the reactor was cooled, and the unreacted vinyl chloride monomer was recovered and removed. Subsequently, the product was dehydrated and dried to provide a vinyl chloride resin.

### Comparative Example 2

A vinyl chloride resin was prepared in the same manner as in Comparative Example 1, except that 1 part by weight of titanium dioxide was further added just before elevating the temperature to 58° C.

### Comparative Example 3

A vinyl chloride resin was prepared in the same manner as in Comparative Example 1, except that 1 part by weight of titanium dioxide, based on 100 parts by weight of the vinyl chloride resin, was further added to the vinyl chloride resin obtained in Comparative Example 1 during the processing and mixing.

The properties of each of the vinyl chloride resins prepared in Examples 1 through 7 and Comparative Examples 1 through 3 above were measured as follows.

(A) Thermal Stability (Measurement of Thermal Degradation Temperature)

After calibrating a thermogravimetric analyzer (TGA), 10.0±0.5 mg of each of the vinyl chloride resins prepared in Examples 1 through 7 and Comparative Examples 1 and 2 was weighed, and the thermal degradation temperature in a nitrogen atmosphere under the conditions indicated in Table 1 below was measured. The results are presented in Table 2.

TABLE 1

| Stage | Start (° C.) | End (° C.) | Rate (° C./min) | Hold (min) | Gas 1 |
|---|---|---|---|---|---|
| Stage 1 | 30 | 50 | 20 | 5 | On |
| Stage 2 | 150 | 500 | 10 | 0 | On |

TABLE 2

| | | Example | | | | | | | Comparative Example | |
|---|---|---|---|---|---|---|---|---|---|---|
| | | 1 | 2 | 3 | 4 | 5 | 6 | 7 | 1 | 2 |
| Weight degradation | 5% | 274 | 271 | 268 | 274 | 272 | 274 | 274 | 266 | 266 |
| temperature (° C.) | 30% | 295 | 310 | 290 | 306 | 308 | 311 | 310 | 288 | 288 |

(B) Thermal Stability During Processing (Measurement of HAAKE Thermal Degradation Time)

Each of the vinyl chloride resins prepared in Examples 1 through 7 and Comparative Examples 1 through 3 was introduced into a mixer with the below-described mixing composition and kneaded for 3 minutes. The thermal degradation time of the mixture was measured in a HAAKE mixer. The results are presented in Table 3 below. Here, the measurement conditions for the HAAKE mixer were set to a temperature of 190° C. and a screw rotation speed of 40 rpm.

Mixing composition: 100 parts by weight of vinyl chloride (copolymer) resin, 5 parts by weight of a composite stabilizer, 6 parts by weight of an impact modifier, 5 parts by weight of calcium carbonate, and 4 parts by weight of titanium dioxide.

TABLE 3

| | | Example | | | | | | | Comparative Example | | |
|---|---|---|---|---|---|---|---|---|---|---|---|
| | | 1 | 2 | 3 | 4 | 5 | 6 | 7 | 1 | 2 | 3 |
| Thermal | Torque (Nm) | 20 | 21 | 22 | 20 | 19 | 17 | 18 | 21 | 21 | 22 |
| stability | Thermal | 1780 | 1832 | 1606 | 1821 | 1846 | 1893 | 1714 | 1644 | 1644 | 1520 |
| during | degradation | | | | | | | | | | |
| processing | time (sec) | | | | | | | | | | |

(C) Whiteness and Weather Resistance

A mixture comprising 100 parts by weight of each of the vinyl chloride resins prepared in Examples 1 through 7 and Comparative Examples 1 through 3, 5 parts by weight of a composite stabilizer, 6 parts by weight of an impact modifier, 5 parts by weight of calcium carbonate, and 4 parts by weight of titanium dioxide was introduced into a mixer and kneaded for 3 minutes. The mixture was then introduced into a HAAKE extruder and extruded at 160, 165, 170, 180 and 190° C. to obtain two 3 mm-thick specimen plates. One of these specimens was used in the measurement of whiteness and yellowness, and the other was used in the measurement of weather resistance by being exposed to a UV lamp for 100 hours. The results are presented in Table 4 below.

TABLE 4

| | | Example | | | | | | | Comparative Example | | |
|---|---|---|---|---|---|---|---|---|---|---|---|
| | | 1 | 2 | 3 | 4 | 5 | 6 | 7 | 1 | 2 | 3 |
| Initial | Whiteness | 72.6 | 74.7 | 68.7 | 74.8 | 74.4 | 74.8 | 75.2 | 65.2 | 70.3 | 68.1 |
| | Yellowness | 1.2 | 1.3 | 2.6 | 1 | 1.4 | 1.2 | 1.6 | 4.2 | 2.2 | 2.8 |
| After weather | Whiteness | 70.3 | 69.7 | 65.2 | 68.9 | 69.9 | 70 | 70.1 | 59.2 | 67.1 | 62.4 |
| resistance test | Yellowness | 3.0 | 3.3 | 5.6 | 3.6 | 3.1 | 3 | 2.9 | 10.4 | 3.2 | 9.2 |

From the results in Tables 2 through 4, it was confirmed that the vinyl chloride resins of Examples 1 through 7 prepared according to the present invention had superior thermal stability, both during processing and in their final products, as well as superior whiteness and weather resistance, when compared with the vinyl chloride resins of Comparative Examples 1 through 3.

While this invention has been particularly shown and described with reference to preferred embodiments thereof, it will be understood by those skilled in the art that various changes in form and details may be made therein without departing from the spirit and scope of the invention as defined by the appended claims.

1. A vinyl chloride resin composition comprising:
100 parts by weight of a vinyl chloride polymer resin; and
0.1 to 30 parts by weight of an organo-modified metal oxide nanoparticle.

2. The vinyl chloride resin composition of claim 1, wherein the metal oxide of the organo-modified metal oxide nanoparticle comprises at least one selected from the group consisting of titanium dioxide, zinc oxide, cadmium sulfide, tungsten trioxide, zirconium oxide, aluminum oxide, and silicon oxide.

3. The vinyl chloride resin composition of claim 1, wherein the organo-modified metal oxide nanoparticle is organically modified using at least one organic substance selected from the group consisting of methylcellulose, hydroxypropylmethylcellulose, hydroxyethylmethylcellulose, an alkyl- or arylcarboxylic acid compound having 6 to 18 carbon atoms, and an alkyl- or arylphosphoric acid compound having 6 to 18 carbon atoms.

4. The vinyl chloride resin composition of claim 1, wherein the average particle size of the organo-modified metal oxide nanoparticle is 10 to 300 nm.

5. The vinyl chloride resin composition of claim 1, further comprising 0.1 to 10 parts by weight of an acrylic resin copolymerized with the 100 parts by weight of the vinyl chloride polymer resin.

6. The vinyl chloride resin composition of claim 5, having a glass transition temperature (Tg) of 100 to 250° C.

7. The vinyl chloride resin composition of claim 1, further comprising at least one additive selected from the group consisting of a thermal stabilizer, a lubricant, a processing aid, an antioxidant, and a photostabilizer.

8. A method of preparing a vinyl chloride resin composition comprising:
preparing a polymerization feed mixture by mixing 100 parts by weight of a vinyl chloride monomer and 0.1 to 30 parts by weight of an organo-modified metal oxide nanoparticle; and
conducting suspension polymerization on the resulting mixture.

9. The method of claim 8, wherein the organo-modified metal oxide nanoparticle is used in a sol state or in a powder state.

10. The method of claim 8, further comprising preparing the organo-modified metal oxide nanoparticle by organically modifying the nanoparticulate metal oxide with at least one organic substance selected from the group consisting of methylcellulose, hydroxypropylmethylcellulose, hydroxyethylmethylcellulose, an alkyl- or arylcarboxylic acid compound having 6 to 18 carbon atoms, and an alkyl- or arylphosphoric acid compound having 6 to 18 carbon atoms.

11. The method of claim 10, wherein the cellulose-based dispersant is used in a 0.5 to 15 wt % solution.

12. The method of claim 10, wherein, during the organic modification of the metal oxide nanoparticle, the nanoparticulate metal oxide is reacted with the organic substance in a ratio of 1:1 to 1:4.

13. The method of claim 8, wherein the polymerization feed mixture further contains 0.1 to 10 parts by weight of an acrylic monomer.

14. The method of claim 13, wherein the acrylic monomer is a compound represented by Formula 1 or Formula 2 below:
[Formula 1] 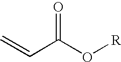
[Formula 2] 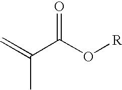
where R is hydrogen, a linear or branched alkyl having 1 to 20 carbon atoms, an aryl having 3 to 16 carbon atoms, or a cycloalkyl having 5 to 8 carbon atoms.

15. The method of claim 13, wherein the acrylic monomer includes at least one monomer selected from the group consisting of methyl (meth)acrylate, ethyl (meth)acrylate, n-butyl (meth)acrylate, isobutyl acrylate, cyclohexyl acrylate, glycidyl (meth)acrylate, phenyl (meth)acrylate, methoxyethyl acrylate, methyl-2-cyanoacrylate, benzyl (meth)acrylate, allyl-2-cyanoacrylate, and 1-ethylpropyl-2-cyanoacrylate.
